(19) United States
(12) Patent Application Publication
(10) Pub. No.: US 2010/0274580 A1
(43) Pub. Date: Oct. 28, 2010

(54) Healthcare Provider Performance Analysis and Business Management System

(76) Inventors: Keith R. Crownover, Hollidaysburg, PA (US); Bonnie A. Yingling, Altoona, PA (US); Gene Kirila, Transfer, PA (US)

Correspondence Address: IN-IP Law Group, P.C., 100 Technology Drive, Suite 400, Pittsburgh, PA, 15219, US

(21) Appl. No.: 12/757,161

(22) Filed: Apr. 9, 2010

Related U.S. Application Data
(60) Provisional application No. 61/168,273, filed on Apr. 10, 2009.

(51) Int. Cl. G06Q 10/00; G06F 17/30; G06Q 50/00

(52) U.S. Cl. 705/2; 707/802; 707/705; 705/7; 707/E17.005

(57) ABSTRACT

A healthcare provider performance analysis and business management system to provide a business-centric analysis of healthcare provider performance indicators. A comparison of the healthcare provider's business performance (as indicated by data collected from the provider for a number of business metrics) against best practices at similarly-situated healthcare providers (as represented by the “benchmarks” used for evaluation of business metrics) may allow the performance analysis system to provide feedback and best practice recommendation to the healthcare provider customer whose business performance is under evaluation. The evaluation of business metrics may proactively identify strengths and weaknesses within a customer's business organization, thereby helping executive management to identify business areas or practices that need the most attention or improvement. Customer-tailored technology solutions may be created to assure measurable and sustainable results. Because of rules governing Abstracts, this Abstract should not be used to construe the claims in this patent application.

### CROSS REFERENCE TO RELATED APPLICATION

This application claims priority benefit under 35 USC §119(e) of U.S. Provisional Application No. 61/168,273 entitled “HEALTHCARE PROVIDER PERFORMANCE ANALYSIS AND BUSINESS MANAGEMENT SYSTEM” and filed on Apr. 10, 2009, the contents of which are incorporated herein by reference in its entirety.

### BACKGROUND

1. Field of the Disclosure

The present disclosure generally relates to analysis of performance of a business and, more particularly, to a business-centric system and method to analyze the performance of a healthcare provider and recommend solutions to improve the same.

2. Brief Description of Related Art

The healthcare industry is a growing, multibillion dollar industry. However, with increasing costs for providing healthcare services and shrinking per-patient net profit, healthcare service providers frequently look for measures to contain costs or improve cost-effectiveness of their services. But, existing approaches to business solutions for the healthcare industry remain patient-centric. That is, current systems or solutions for business performance analysis and improvement for businesses in the healthcare industry view the healthcare system from a patient's point of view and then offer solutions accordingly to improve or manage the products or services offered to the patient or to improve patient's diagnosis and treatment. This patient-centric approach fails to provide additional perspective on data points and may not be well-equipped to address needs of and offer solutions for management of a healthcare practice as a business (and not merely a patient-treatment facility).

Hence, it is desirable to devise a system that can provide a business-centric analysis of customer (i.e., a healthcare provider) performance indicators so as to provide additional perspective on data points not currently available in other, patient-centric systems or solutions. It is further desirable that the business-centric analysis system be able to create customer-tailored technology solutions that assure measurable and sustainable results and that the analysis system be able to proactively identify strengths and weaknesses within a customer's business organization, thereby helping executive management to identify business areas or practices that need the most attention or improvement.

### SUMMARY

The present disclosure relates to a system and method to analyze the performance of a healthcare provider agency/customer and recommend business solutions to the customer such as, for example, how to improve efficiency, lower operating costs, increase satisfaction from persons or entities receiving healthcare services from the customer/agency, exceed clinical and financial benchmarks, improve profitability in various tasks handled by the agency, etc. In contrast to the patient-centric approach of existing systems or solutions (which view the healthcare system from a patient's point of view and then offer solutions accordingly to improve or manage the products or services offered to the patient or to improve patient's diagnosis and treatment), the present disclosure relates to a business-centric approach that not only offers solutions for increased profitability for the healthcare service provider, but in doing so, also ends up improving the management and delivery of healthcare services to its ultimate intended recipient—the human patient.

In one embodiment, the present disclosure relates to a method, which comprises: receiving, using a first computing system, business metric-specific data for a plurality of business metrics for a healthcare provider; analyzing the received data using the first computing system; and providing a performance report using the first computing system based on the analysis of the received data, wherein the performance report is tailored to the healthcare provider and reports a measurement of business performance of the healthcare provider against the plurality of business metrics. The analysis includes evaluation of the received data against a pre-determined set of benchmarks related to the plurality of business metrics.

In another embodiment, the present disclosure relates to a method that comprises: configuring a first computing system associated with a business entity to maintain a database containing business metric-specific data for a plurality of business metrics for the business entity; and configuring a second computing system to perform the following: receive the business metric-specific data from the first computing system, analyze the received data, and provide a performance report based on the analysis of the received data, wherein the performance report is tailored to the business entity and reports a measurement of business performance of the business entity against the plurality of business metrics.

In a further embodiment, the present disclosure relates to a computer program code. The computer program code comprises a first program code and a second program code. The first program code, when executed by a first computing system associated with a business entity, configures the first computing system to collect business metric-specific data for a plurality of business metrics for the business entity. And, the second program code, when executed by a second computing system, configures the second computing system to: (i) receive the business metric-specific data from the first computing system, (ii) analyze the received data, and (iii) provide a performance report based on the analysis of the received data, wherein the performance report is tailored to the business entity and reports a measurement of business performance of the business entity against the plurality of business metrics.

The healthcare provider performance analysis and business management system according to the teachings of the present disclosure provides a business-centric analysis of healthcare provider performance indicators. A comparison of the healthcare provider's business performance (as indicated by data collected from the provider for a number of business metrics) against best practices at similarly-situated healthcare providers (as represented by the “benchmarks” used for evaluation of business metrics) may allow the performance analysis system to provide feedback and best practice recommendation to the healthcare provider customer whose business performance is under evaluation. The evaluation of business metrics may proactively identify strengths and weaknesses within a customer's business organization, thereby helping executive management to identify business areas or practices that need the most attention or improvement. Customer-tailored technology solutions may be created to assure measurable and sustainable results.

### BRIEF DESCRIPTION OF THE DRAWINGS

For the present disclosure to be easily understood and readily practiced, the present disclosure will now be described for purposes of illustration and not limitation, in connection with the following figures, wherein:

FIG. 1 shows a simplified system diagram illustrating how customer's (i.e., a healthcare provider's) and software vendor's systems interact to implement the workflow of various tasks associated with the healthcare provider performance analysis and business management system—hereafter referred to as the Assured Performance (AP) system—according to one embodiment of the present disclosure;

FIG. 2 illustrates daily data collection and transfer from a customer's system to the vendor's system, and daily data aggregation at the vendor's system;

FIG. 3 provides an exemplary list of various types of data (which may include financial, clinical, and operational data of a customer's business) that may be collected for analysis by the AP system according to one embodiment of the present disclosure;

FIG. 4 illustrates exemplary software modules or processes of an AP system according to one embodiment of the present disclosure;

FIG. 5 shows exemplary details of the AP system workflow according to one embodiment of the present disclosure;

FIG. 6 illustrates exemplary database tables or data segments that may be reported by the customer and maintained at the data repository by the vendor as part of an AP system according to one embodiment of the present disclosure;

FIG. 7 shows exemplary home health (HH) compare tables and their content for an AP system according to one embodiment of the present disclosure;

FIG. 8 shows exemplary Assured Performance (AP) tables and their content for an AP system according to one embodiment of the present disclosure;

FIG. 9 illustrates an exemplary set of business metrics (or performance indicators) and its association with corresponding areas of operation in the business of a healthcare customer;

FIG. 10 shows an exemplary flowchart depicting how individual and aggregate case recommendations may be provided by the vendor's AP system upon analysis of specific data collected (e.g., by a customer's representatives) from individual as well from multiple patients (or general population); and

FIG. 11 illustrates an exemplary embodiment depicting how the AP system according to the teachings of the present disclosure may use individual and aggregate data collected as per the embodiment in FIG. 10 with various KPI (key performance indicators) and best practice data to generate business outcome recommendations for a customer.

### DETAILED DESCRIPTION

The accompanying figures and the description that follows set forth the present disclosure in embodiments of the present disclosure. It is to be understood that the figures and descriptions of the present disclosure included herein illustrate and describe elements that are of particular relevance to the present disclosure, while eliminating, for the sake of clarity, other elements found in typical computer systems or client-server arrangements. It is contemplated that persons generally familiar with designs, maintenance, implementation, or operation of software distribution systems or software-based data analysis systems, will be able to apply the teachings of the present disclosure in other contexts by modification of certain details. Accordingly, the figures and description are not to be taken as restrictive of the scope of the present disclosure, but are to be understood as broad and general teachings.

It is noted at the outset that the terms “coupled,” “connected”, “connecting,” “electrically connected,” etc., are used interchangeably herein to generally refer to the condition of being electrically connected. It is further noted that various figures shown and discussed herein are for illustrative purpose only, and are neither drawn to scale nor representative of complete implementaional details of a data collection, monitoring, and analysis system. Unless specifically stated otherwise or as apparent from the discussion herein, it is appreciated that the terms such as “processing,” “computing,” “calculating,” “determining,” “comparing,” “analyzing,” “evaluating,” “displaying” or the like are used herein to refer to the action and processes of a computer system or similar electronic computing device, that manipulates and transforms data represented as physical (electronic) quantities into other data similarly represented as physical quantities within the computer system's memories or registers or other such information storage, transmission, or display devices.

Some portions of the description herein may be presented in terms of algorithms and symbolic representation (or flowchart) of operations. These algorithmic descriptions and representations are the means used by those skilled in the data processing arts to most effectively convey the substance of their work to others. An algorithm or flowchart is here, and generally conceived to be a self-consistent sequence of steps leading to a desired result. The steps may require physical manipulations of physical quantities. Usually, though not necessarily, these quantities take the form of electrical or magnetic signals capable of being stored, transferred, combined, compared, and otherwise manipulated.

The algorithms, figures, software functionality, and flowcharts presented herein are not inherently related to any particular computer or other apparatus. Various general purpose computer systems may be used with programs in accordance with the teachings herein, or it may prove convenient to construct more specialized apparatus to perform the program code functionality discussed herein. In addition, the present disclosure is not described with reference to any particular programming language. It will be appreciated that a variety of programming languages may be used to implement the teachings of the present disclosure as described herein.

The program code (or a portion thereof) discussed herein may be stored in a machine-readable medium of a corresponding computer system (e.g., a vendor's computer system or a customer's computer system discussed below with reference to FIG. 1). This program code, when executed by a processor in the corresponding computer system, configures the computer system to perform various related tasks discussed hereinbelow. The machine-readable medium may include, for example, a read only memory (ROM), a random access memory (RAM), a magnetic disk storage medium (e.g., a floppy disk), an optical disk (e.g., a compact disc or a DVD), a flash memory, or any other suitable data storage medium readable by a machine (e.g., a computer).

As discussed in more detail below, data collected from a healthcare service provider may correspond to a number of business metrics or performance indicators. The collected data then may be analyzed against a pre-determined set of benchmarks to identify the “health” of the service provider's business—e.g., whether the service provider's business meets or exceeds the industry “standard” benchmarks, whether the business remains competitive in the marketplace, whether the business is profitable as it should be or whether the business model needs improvement or changes. The results of analysis of service provider's business “health” may be reported to the service provider for implementing necessary changes or improving the business towards further profitability.

FIG. 1 shows a simplified system diagram illustrating how customer's (i.e., a healthcare provider's) and software vendor's systems interact to implement the workflow of various tasks associated with the healthcare provider performance analysis and business management system—hereafter referred to as the Assured Performance (AP) system—according to one embodiment of the present disclosure. In one embodiment, various tasks associated with the AP system may be carried out via software, thereby significantly automating those tasks. For example, data collection, aggregation, analysis, and result-reporting aspects may be carried out via software. It is noted here that the terms “customer,” healthcare provider,” “healthcare service provider,” “service provider,” “healthcare agency,” “agency,” “client firm,” or other terms of similar import are used interchangeably herein to refer to a healthcare provider business entity whose business performance is under evaluation. Similarly, the terms “vendor” or “software vendor” are used interchangeably herein to refer to a business entity providing the software containing the AP system according to the teachings of the present disclosure. The term “vendor” and “customer” may not necessarily have a direct business or contractual relationship. In FIG. 1, although the software vendor (i.e., the vendor's computer system 10) is shown to receive and analyze data from the healthcare provider customer (i.e., the customer's computer system 12), it need not be so. The software containing AP system may be developed by a software vendor, whereas a different entity may provide the data analysis service using the software procured from the software vendor.

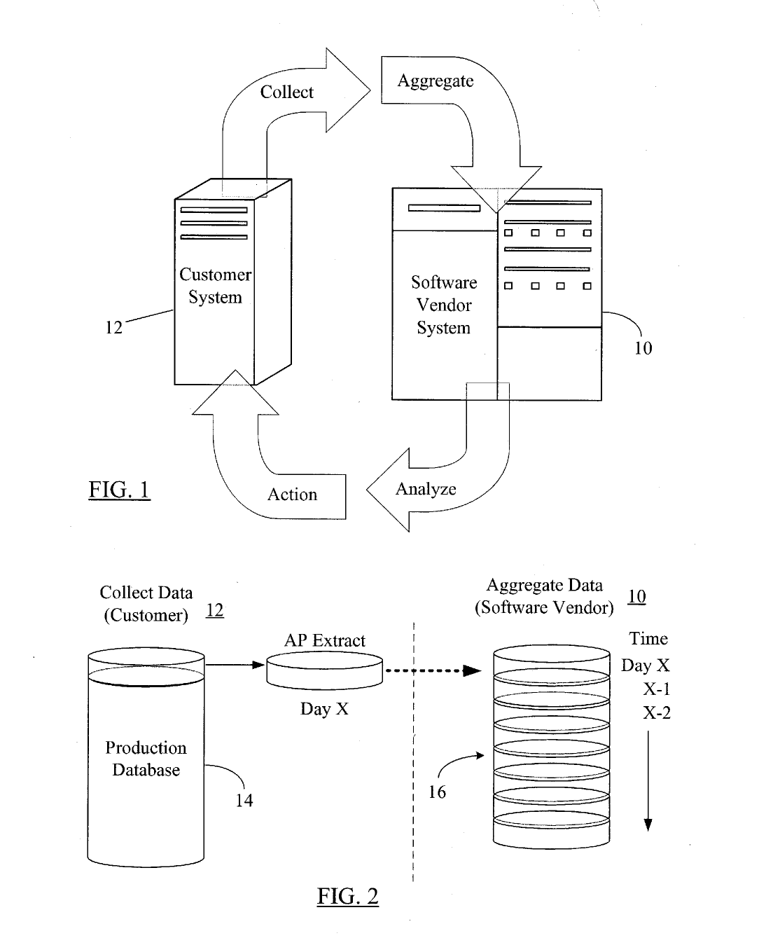

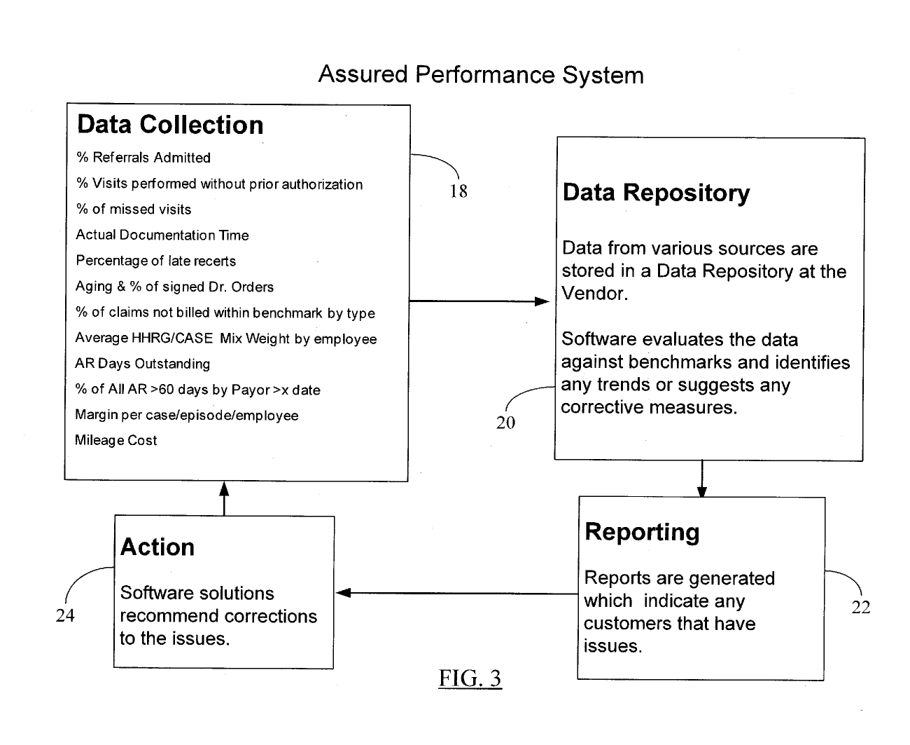

As illustrated in FIG. 1, the customer (e.g., a home healthcare agency) may collect various types of data (discussed below with reference to FIG. 3) and submit the data to the AP system of the vendor. The data submission may be manual (e.g., initiated by customer at pre-determined or customer-selected time intervals) or automatic (e.g., the AP system software may periodically “pull” data from customer systems 12 linked with the vendor's computer 10 hosting the software for the AP system). FIG. 2 illustrates daily data collection and transfer from a customer's system to the vendor's system, and daily data aggregation at the vendor's system. For example, as shown in FIG. 2, in one embodiment, the customer's system 12 may maintain a database 14 storing (e.g., on a daily basis) content of specific data to be input to the software vendor's AP system 10 for analysis and evaluation. The customer system 12 may then transfer the current day's (e.g., “Day X” in FIG. 2) data file to a database 16 maintained at the vendor's site or system 10. Such data transfer may take place on a daily basis at a predetermined time (e.g., every night at midnight). As shown in FIG. 2, the AP system vendor may aggregate all daily-reported data from all such customers for further evaluation and analysis (as discussed later hereinbelow). Data collected from various sources may be aggregated in a data repository—a part of the AP system—and evaluated against known benchmarks to identify the business trends in customer's business and recommend appropriate actions or corrections as discussed in more detail below.

In one embodiment, the data communication arrangement depicted in FIGS. 1 and 2 may be based on a client-server framework—with the software vendor's system 10 functioning as a “server” for the customer's “client” system 12. Alternatively, the AP system configurations in FIGS. 1 and 2 may be implemented using any suitable computing environment such as, for example, a peer-to-peer (P2P) or a master/slave configuration. Although not shown in FIGS. 1 and 2, the customer and vendor computing systems 12, 10 may communicate with each other via a combination of wired and wireless communication networks including, but not limited to, for example, the Internet, a LAN (local area network), a WAN (wide area network), a VPN (virtual private network), etc. Furthermore, although a single vendor system 10 is shown in FIGS. 1 and 2, the functionality of the software implementing the AP system according to the teachings of the present disclosure may be distributed over a network of host machines (not shown) managed by or associated with the software vendor. Similarly, the customer system 12 may comprise of a distributed network of computing units, which may then individually or collectively communicate with the vendor system. As is evident, the software vendor's AP system may serve many such customers or agencies, even though only one customer/agency is represented in FIGS. 1 and 2 (by way of exemplary computer system 12).

In one embodiment, a portion of the program code for the AP system may be embedded within a healthcare management software product (not shown) that the software vendor may sell to the healthcare agency/customer (e.g., the Encore® home healthcare management software available from Delta Health Technologies of Altoona, Pa.). At the time of activation of the software product, the vendor may request the customer to authorize the automatic data collection by the embedded code and automatic remote reporting of the collected data using the embedded program code to initiate data reporting to the vendor database at predetermined times or frequencies. So long as such data collection and/or reporting is not in violation of any health laws or regulations (e.g., the HIPAA—Health Insurance Portability and Accountability Act), the customer may find it convenient to have the vendor's AP system automatically “monitoring” customer's business functions on a routine basis. It is noted here that the customer-based portion of the AP system program code, when executed by the customer's computer system 12, may configure the customer's system 12 to perform data collection, database creation/maintenance, and various other tasks as described hereinbelow with reference to the discussion of the functionality of the AP system. Similarly, the vendor-based portion of the AP system program code, when executed by the vendor's computer system 10, may configure that system 10 to perform data aggregation, analysis, and various other AP system-related tasks described hereinbelow with reference to the discussion of the functionality of the AP system.

FIG. 3 provides an exemplary list of various types of data items (which may include financial, clinical, and operational data items of a customer's business) for which data may be collected for analysis by the AP system according to one embodiment of the present disclosure. The types of data items listed below may be interchangeably referred to as “business metrics” or “performance indicators.” Some exemplary business metrics for which data may be collected (and/or maintained in the database 14) by the customer's system 12 may include, but is not limited to, the following:

(i) Percent Referral Admitted—Total number of patient referrals in a given date range and the percentage of that total that are admitted for service.

(ii) Number of visits performed without prior authorization and the percentage of the total number of services provided that this represents. (Many insurers require prior authorization of service.) Oftentimes this includes the number of services by a nurse, and the number of services by a physical therapist (by discipline). Other payers may merely authorize a number of services. The data related to number of visited without prior authorization and the percentage of such visits (as compared to all patient visits in a given period) may be tied back to the revenue lost due to non-reimbursement (e.g., by an insurer when the visit was not pre-authorized).

(iii) Number of missed visits and the percentage of the total number of visits provided that the missed visits represent. Missed visits would be visits that were ordered but not performed. The missed visits data may be tied back to the revenue lost by missing the visit.

(iv) Actual documentation time—the amount of time spent recording clinical encounters. This data may include what was actually documented at the point-of-care and what was not documented at the point of care.

(v) Percentage of claims not billed—This data may include the percentage of total claims that was not billed within a given benchmark type (e.g., all hip surgery claims, or all home physical therapy visit claims)

(vi) Accounts Receivable (AR) days outstanding—This data represents actual days outstanding for accounts receivable (“aging AR”).

(vii) Percentage of all AR>60 days, and Payer>X date—This data may include (a) the number of account receivables that have been on file for 60-89 days, grouped by payer, (b) account receivables that have been on file for 90-119 days, grouped by payer, (c) account receivables that have been on file for 120 days or more, grouped by payer, (d) total of account receivables, regardless of age, by payer, (e) total of all accounts receivables by age, regardless of payer, and (f) total of all accounts receivables, regardless of age or payer.

(viii) Supply cost average by patient admission—Cost of supplies utilized for the case. (The data related to actual profit and loss (P&L) relative to supplies may be useful, since not all of the supply cost may be covered by the reimbursement (e.g., from an insurance company)).

(ix) Mileage cost average by patient admission—In a home healthcare situation, since the care is provided in the patient's home, there is a mileage cost for the clinician to get to and from the patient's home.

(x) Profit and Loss (P&L) per case—An actual P&L for each admission (or case) including the margin per case.

(xi) Profit and Loss (P&L) per Clinician—An actual P&L for each clinician caseload in a given date range, including the margin.

(xii) Profit and Loss (P&L) per Referral Source—An actual P&L for each referral source and admitted referrals in a given date range, including the margin.

(xiii) Profit and Loss (P&L) per Diagnosis type—An actual P&L for each of the top 10 diagnoses (using both the primary diagnosis and co-morbidities for a case) in a given date range, including the margin.

(xiv) Percentage of late recerts—The percentage of patient recertifications (“recerts”) that are late. In home healthcare, for example, patients can be recertified into another episode of care if they meet certain regulatory standards. A site director may make a patient-by-patient clinical decision on discharge or recertification. Lateness in recertifying may delay patient care delivery and, hence, may also delay timely receipt of revenue related to the recertified treatment plan.

(xv) Aging and percentage of signed doctor orders—This data represents doctor orders not yet executed or acted on by the healthcare provider agency/customer, and the days by which execution of such orders have been delayed (“aging orders”). The doctor orders may include certification and recertification plan of treatment orders and interim orders.

(xvi) Average home health resource group (HHRG)/case mix weight by employee—This refers to Home Care Agency's patient population where Medicare is the primary payer for services. Under the Medicare Prospective Payment System, the Outcomes Assessment Information Set (OASIS), which is a standardized government defined survey that must be performed at specified time points through the course of care for all Medicare and Medicaid patients, is utilized to calculated the prospective reimbursement for the a 60-day period of care. The HHRG (and the associated numeric case mix weight number) is an integral part of the reimbursement calculation and may be used to identify, for each clinician (employee), the average HHRG and resulting case mix weight for the clinician's case load (identified by the primary clinician).

From above, it is observed that, in one embodiment, exemplary business metrics may fall under five categories:

(1) Referral Data (including, but not limited to, for example, percentage of referrals admitted, percentage of patients referred but not taken under care, percentage of referrals in process, number of referring physicians, unduplicated census data (daily average), and unduplicated census data for patients receiving tele-monitoring services (daily average);

(2) Home Health Risk Adjusted Patient Outcomes Data (including, but not limited to, for example, percentage of patients walking or moving around, percentage of patients getting in/out of bed, percentage of patients whose bladder control improves, percentage of patients who express less pain moving around, percentage of patients who appear better at bathing, percentage of patients who appear better at taking medicines, percentage of patients who express short of breath less often, percentage of patients admitted to hospital, percentage of patients requiring urgent unplanned care, percentage of patients who stay at home after episode, percentage of patients needing care due to wound not healing, and percentage of patients whose wounds improved or healed after operation);

(3) Homecare and Hospice Quality. Assurance Performance Improvement (QAPI) data;

(4) AR or Financial Data (including, but not limited to, for example, percentage of All AR>60 days, and by Payer>x date, Supply Cost, Labor Cost, average Cost per case/episode, average Revenue per case/episode, Margin per case/episode/employee, Mileage Cost, and AR Days Outstanding); and

(5) Operations Measures (including, but not limited to, for example, aging and percentage of signed Dr. Orders (e.g. certification and recertification plan of treatment orders and/or interim orders) by days, percentage of Patients Admitted within 48 hours of referral, percentage of home healthcare visits completed as ordered, and financial impact of visits per healthcare discipline per 60-day period.)

Referring again to FIG. 3, and as already noted hereinbefore, the data collected from a customer's system (as represented by the block 18 in FIG. 3) may be stored as part of a data repository (represented by block 20 in FIG. 3) maintained by the vendor or some other party, such as, for example, publicly available CMS Home Health Compare, and then evaluated against benchmarks (by the vendor's AP system software) to identify any trends in the customer's industry and suggest corrective measures, if needed, to the customer. In one embodiment, publicly-available industry “standard” data may be used as benchmarks to evaluate various business metrics. Alternatively, proprietary benchmarks may be devised by the vendor based on data collected from its customers and/or other sources over time. In this latter case, the data repository at the vendor may “evolve” over time and become statistically significant when data (related to business metrics) are collected over a longer period of time from a large number of customers. On the other hand, industry standard data associated with pre-defined business metrics may be collected from publicly available sources or surveys, and used for comparison with the collected customer-specific data to measure customer's business performance. In any event, the benchmarking operation comprises measuring performance of a healthcare provider's business against business performance of other, similarly-situated healthcare providers or against an accepted industry standard for such businesses.

In one embodiment, the business metrics outlined above (and listed, for example, in block 18 in FIG. 3) may have corresponding benchmark data—calculated by the software vendor from state or national averages for such activities or heuristically determined by the vendor upon analysis of data collected from its customers—for evaluation of the customer's business performance. For example, if a benchmark indicates that the average state-wide time for outstanding AR days is 45, then a particular customer's business model may need correction if the outstanding AR days for that customer consistently average over 60 days. Similarly, for example, if data from a vendor's other customers indicate that the percentage of patient visits performed without prior authorization averages in the range of 7-10% for those customers, then another customer whose data indicates a value of 3-5% for this business metric may be considered doing “above average” and, hence, may receive a commendable or positive report on this business metric. Other business metrics may be similarly evaluated against known, evolved, and/or calculated benchmarks.

It is observed that, in certain situations, it may be desirable for the AP system to evaluate performance indicators using weighted benchmarks. For example, some benchmarks (e.g., billings and collection-related benchmarks or benchmarks related to business performance) may need to assign more weight than some other benchmarks (e.g., benchmarks related to patient management) probably because of different business/commercial significance of various benchmarks In that event, the software for the AP system may be configured to assign different weights to different benchmarks, thereby more closely following business trends in the relevant healthcare industry. In the weighted evaluation, the report provided to a customer may indicate the relative importance of various benchmarks in business performance evaluation and the weighting methodology.

In one embodiment, variables or measures may be weighted differently depending upon the Key Performance Indicator (KPI) that is being evaluated. For example, the weight of the number of nursing services may be higher (e.g., a weighting of 5, on a scale of 1 to 5) when measuring the impact on the profit margin for the individual patient case when the primary reason for service is to improve independence in regard to feeding oneself and the patient is 94 years of age. The nursing services may also be weighted differently depending upon the type of service that is being provided. For example, an initial admission service may be weighted higher than a routine nursing visit due to the effort required to complete an admission visit. This could be a factor considered in the calculation of employee productivity and it may influence staffing patterns, etc., which can also have an impact on profit margins, etc.

It is noted here that data collected from the customer may include patient data that need to be de-identified prior to its delivery to the vendor to comply with ethical and legal (e.g., HIPAA) responsibilities to protect patient's privacy. The “de-identified data” may include patient data from which all information that could reasonably be used to identify the patient has been removed (e.g., patient's name, address, social security number, etc.). De-identification may be performed manually or automatically by the customer system 12. Furthermore, encryption may be used to de-identify certain patient data. De-identification of data may also help reduce the file size of the data to be transferred to the vendor, thereby enhancing data query and transfer performance. A customer, however, may not use the AP system as a patient data mining tool. (However, the portion of the AP system program code executed by the customer system 12 may offer such data mining and de-identification functionality to use as desired.) Prevention of data misuse may require customers to have dashboards on their computer systems; the templates for such dashboards may be supplied by the software vendor.

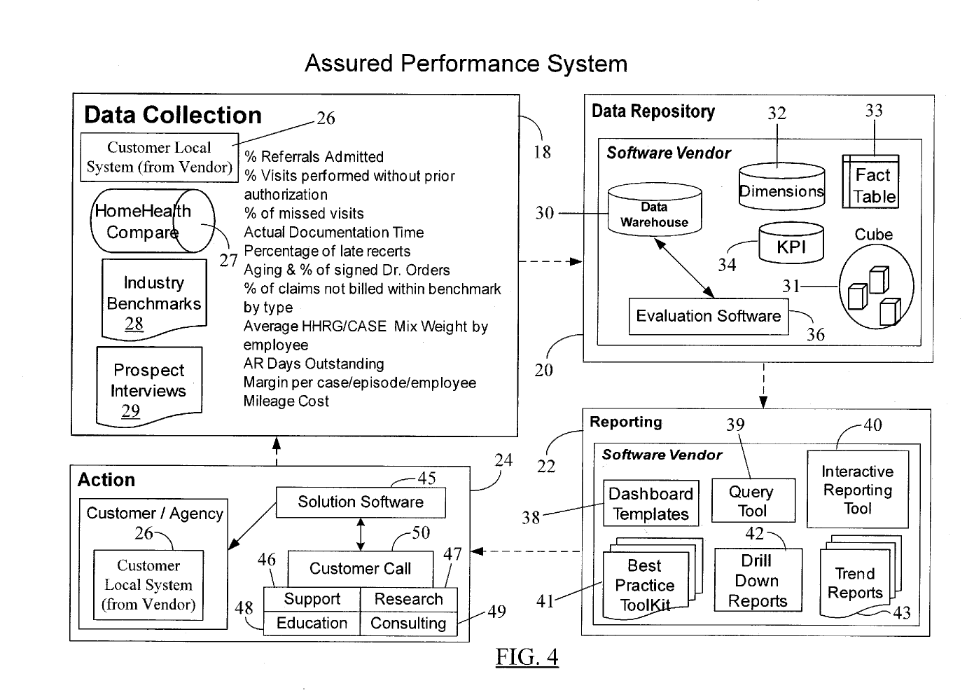

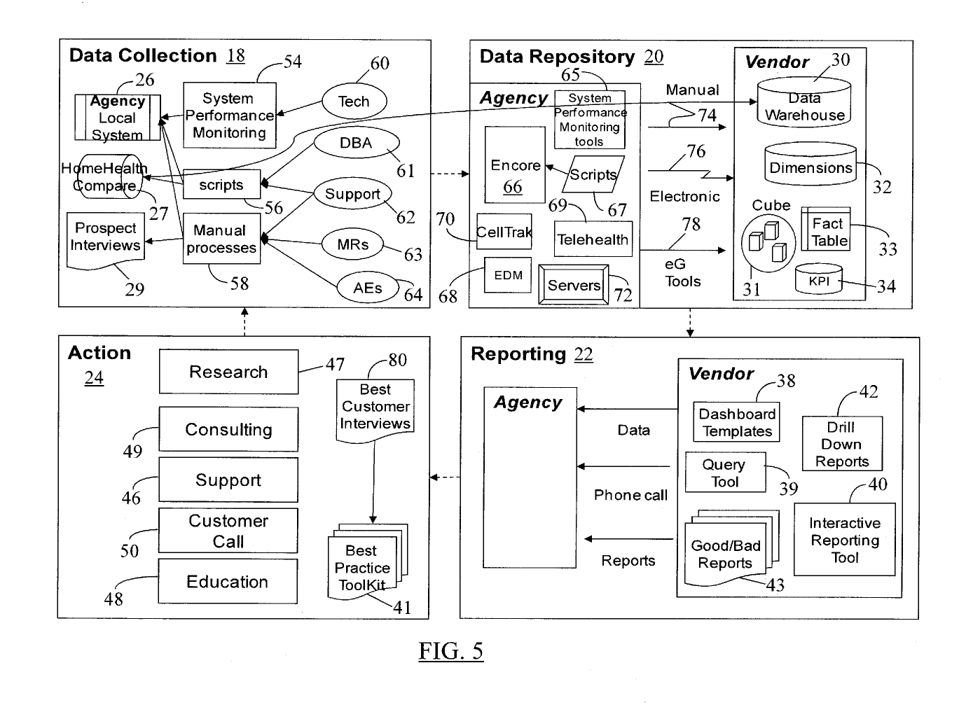

As shown in FIG. 3, after analysis of customer data, one or more reports (block 22) may be generated indicating how customer's business activities fare against the benchmarks, and pointing out specific area(s) for improvement for customers that have business performance-related issues (as indicated by the benchmark-based analysis operation). Various types of exemplary reports and reporting options are shown in FIGS. 4 and 5 and discussed later hereinbelow. The reports and suggested solutions may be electronically provided (block 24) as software modules that could be sent to the AP software portion embedded in the customer's healthcare management software (as mentioned before). Additional exemplary action-taking approaches are also shown in FIGS. 4 and 5.

In one embodiment, data may be collected from the customers free of charge. However, the results of data analysis and reports generated therefrom may be sold to customers by charging fees, for example, per report, per group of reports, or a fixed “subscription” fees to cover reports over a specified time period (e.g., six months, a year, etc.). Alternatively, some reports or some analysis results (e.g., monitoring of some performance indicators, availability of a mini dashboard template depicting some pre-determined minimum reporting details, etc.) may be shared with customers free of charge in exchange for their submission of data to the vendor. However, additional or comprehensive reports or detailed analysis may incur charge. The vendor may also provide a fee-based customer business performance monitoring service using the business metrics evaluation approaches according to one embodiment of the present disclosure. Additional or alternative fee arrangements for data collection and report delivery may be contemplated as desired.

FIG. 4 illustrates exemplary software modules or processes of an AP system according to one embodiment of the present disclosure. As shown in FIG. 4, the data collection aspect (block 18) may be performed using various software processes to collect data related to various business metrics or performance indicators. As mentioned before, a portion of the program code for the AP system may be embedded in a healthcare management software product supplied by the vendor (block 26) and may include, for example, software processes (e.g., automated tools or scripts) 27-29 to collect data related to patient/prospect interviews, industry benchmarks, and comparison of healthcare services provided by personnel employed by the customer. Software tools and automated scripts may be employed to streamline data collection. The vendor's data repository may include a data warehouse 30 (e.g., the database 16 in FIG. 2) where data received from the customer may be retained for analysis by the evaluation software component of the AP system. In one embodiment, data for the AP system may be collected without requiring dashboard cubes 31 to conserve hard drive capacity at small or price-sensitive agencies. The data repository at the software vendor may also include dimensional data 32 and fact tables 33 (e.g., industry-specific “standard” benchmarks) as well as data related to key performance indicators (KPI) 34 that may be used by the evaluation software 36 to analyze the customer-collected data for business metrics. The AP system software may provide a number of reporting options (block 22) to report results of analysis of customer data by the evaluation software module 36. In one embodiment, depending on the desired sophistication and depending on the customer-selected payment plan, the reporting options may include one or more of the following: dashboard templates 38, query tools 39, interactive reporting tools 40, best-practice toolkits 41, drill down reports 42, and industry trend reports 43 (or “good/bad reports” shown in FIG. 5). Dashboard may be created to streamline the monitoring of existing customers' business-critical metrics. An Action Process (not shown in FIG. 4) may be developed to handle any negative information that comes from the customer's dashboard. A Solutions module 45 may electronically transmit the customer-specific reports to the customer's local healthcare management software system 26, and may include reports and recommendations related to customer support (block 46), research (block 47), education (block 48), and consulting activities (block 49). A phone call to the customer (block 50) may be automatically initiated to discuss results of customer's report with a support representative of the vendor.

FIG. 5 shows exemplary details of the AP system workflow according to one embodiment of the present disclosure. Various software modules/processes shown in FIG. 5 have been already discussed hereinbefore with reference to discussion of FIG. 4, and, hence, such discussion is not repeated herein for the sake of brevity. As shown in FIG. 5 under the “Data Collection” aspect of the AP workflow (block 18), software processes for collecting data may further include healthcare expert group (eG) or system performance monitoring process 54, automated scripts 56, and manual data collection processes 58. Various sources of data may include, among others, healthcare technologists 60, database administrators (DBA) and support personnel 61-62, marketing representatives (MRs) in the field 63, account managers and account executives (AEs) 64. These sources may provide important information about various aspects of customer's healthcare business (e.g., mileage cost, percentage of missed visits, AR days outstanding, actual documentation time, and other business metrics discussed hereinbefore), and the analysis of such information using the AP system software may provide useful data to the customer regarding the financial, operational, systems and competitive “health” of its healthcare business. The customer may use a number of software tools (block 65) and/or technology solutions to report the collected data to the software vendor. Such tools may include, for example, a healthcare management database (e.g., a production DB) and scripts running thereon (blocks 66-67), an electronic document or data management tool (block 68), a telehealth service module or other healthcare management solution (e.g., the CellTrak™ software module) (blocks 69-70), and one or more server systems (block 72) at the customer's site.

As shown in FIG. 5 under the “Data Repository” block 20, the data reporting form the customer may be manual 74 (e.g., a customer representative may manually provide the collected data to a vendor representative to be input into the AP system database), electronic 76 (e.g., automatically via a communication link), or using specialized expert group (eG) software tools 78. Additional reported measures may include, but are not limited to, the following:

1) System Monitoring: a) server status and performance information, b) Windows® scheduled tasks (did they run as per schedule?, did they complete successfully?, errors if not successful), c) SQLServer Backup Status (have the databases for the home care agency systems been backed up at least daily?), d) number of licensed mobile devices, e) successful communications of mobile devices (which mobile devices did not complete a successful synchronization of data with the in-office aspect of the solution—by day, week and/or month), and f) which mobile devices have the largest number of patient records going to the device (could be a discrete number or a threshold), g) software version for the in-office component of a solution, h) software version for each mobile device, i) ten most fragmented indexes in a database—to help determine if a database is running efficiently. One can calculate an index based on the area that an index is using, and the amount of space that the index needs to use. If the index is being inefficient with the amount of space, it will have a low score. A table with perfectly un-fragmented indexes will have a score of 100. This section may list the worst tables. The software tool represented by block 65 may be used to report such system monitoring.

2) Financial Data: a) number of prior month visits not entered by close of the accounting month. For example the current month is January, and the December accounting month was closed by January 5th. What is the number of services (visits) for the month of December that were entered on or after the January 5th date? Include the type of service for each of the services and the clinician performing the service, b) labor costs by admission, by employee and/or by Primary Diagnosis, c) amount of AR yet unbilled due to awaiting physician signature on orders (certification/recertification plan of treatment or interim orders).

3) Operational Measures: a) hours/FTEs (full-time equivalents) allocated to scheduling of patient services, b) average travel time per day by unit line of service and/or by clinician, c) hours/FTEs (full-time equivalents) spent on quality assurance functions with the home care agency, number of scheduled services (visits) per day.

It is observed here that various data elements related to implementation of the AP system may also be taken into account by the vendor or other AP system provider. In one embodiment, such data elements may address issues or relate to data such as, for example, pass/fail status of nightly communications between customer systems and the vendor's AP system, the success rate of interface between the customer and vendor systems, the success and/or failure of data exchange interfaces, the last run time of AR generation, account balancing reports and validations, checking for errors related to imports, history, and service validations, review of billing errors by Medicare Prospective Payment System utilities, verification of surround application services running across all server systems in the customer's business enterprise, interface synchronization options on the surround server, the success and/or failure of the Health Level 7 (HL7) data exchange interfaces, the performance of web services related systems within the customer's business enterprise, and the transmission status of outbound data transmissions, such as, for example, Outcomes Assessment Information Set (OASIS).

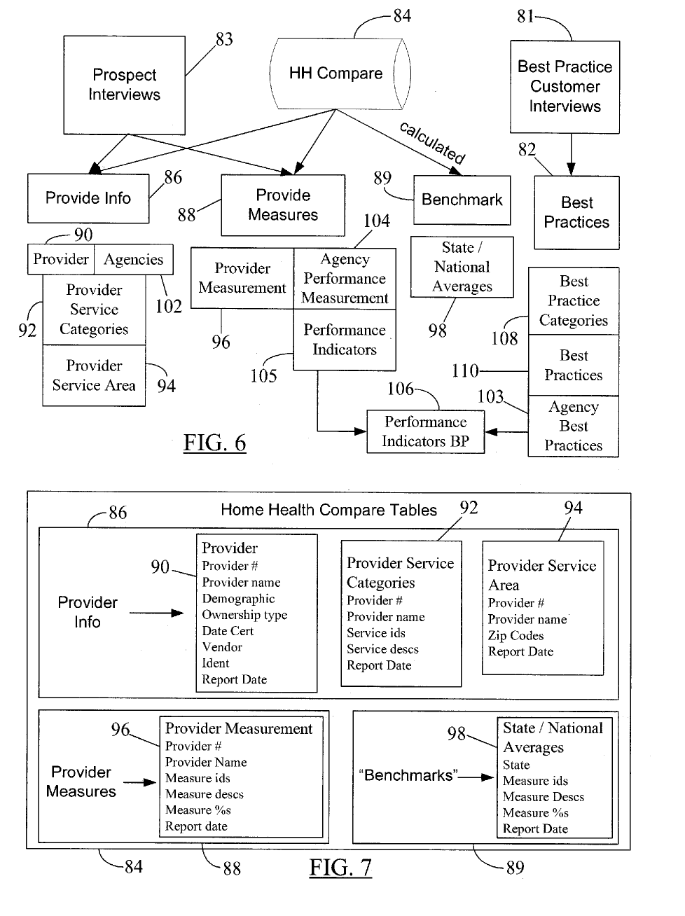

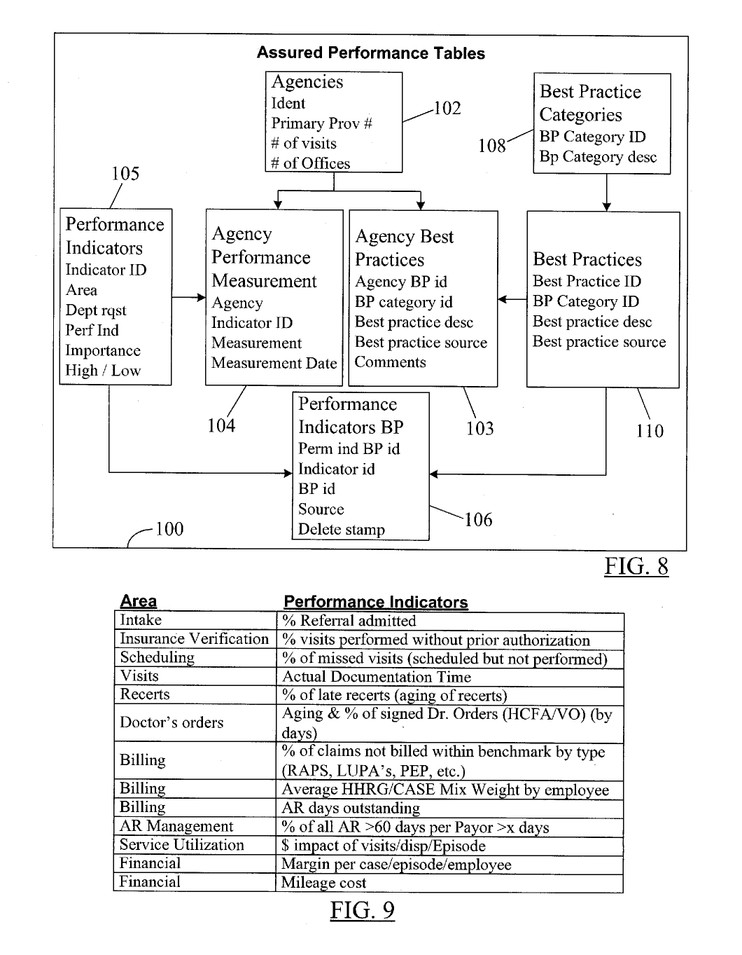

FIG. 6 illustrates exemplary database tables or data segments that may be reported by the customer and maintained at the data repository by the vendor as part of an AP system according to one embodiment of the present disclosure. For example, data collected from interviews with various other customers or agencies regarding their best practices in different healthcare categories (block 81) may be stored as part of a “Best Practices” table (block 82) in a suitable portion of the data repository maintained by the software vendor or other AP service provider. Similarly, information (e.g., service category, service area) about healthcare providers and/or agencies may be collected (by the customer) from interviews with prospects (patients or another intermediary healthcare agency) (block 83) or from home health (HH) compare tables 84 (e.g., in case when the customer is a home healthcare agency) and stored as part of a “Provider Info.” table (block 86) in the AP system database operated by the vendor. The HH compare tables 84 (e.g., shown under the “Data Collection” block in FIGS. 4-5) may also provide data for a “Provider Measures” table (block 88) and a “Benchmark” table (block 89) that may be maintained at the vendor database as well. Healthcare provider and agency performance measures may be stored in the “Provider Measures” table 88, whereas a “Benchmark” table 89 may be calculated using data collected from the customers regarding state and national averages for various categories of healthcare services handled by the AP system for its customers. Various types of data collected for different tables are listed under each table in FIG. 6 and shown in more detail in FIGS. 7 and 8. It is noted here that the data represented by reference numerals 81, 83, and 84 may be identical or substantially similar to the data collected and reported by the customer/agency and represented by reference numerals 80 (FIG. 5), 29, and 27, respectively, as shown in FIGS. 4 and 5.

FIG. 7 shows exemplary home health (HH) compare tables (block 84 in FIG. 6) and their content, whereas FIG. 8 shows exemplary Assured Performance (AP) tables (block 100, representing other non-HH compare related content in FIG. 6) and their content for an AP system according to one embodiment of the present disclosure. The data associated with the HH compare tables 84 and the AP tables 100 may be stored as part of the database for the vendor's AP system as mentioned above with reference to discussion of FIG. 6. As shown in FIG. 7, the HH compare tables 84 may contain data about Providers (block 90) (e.g., provider's (e.g., a doctor's or nurse's) name, license number, demographic info., etc.), Providers' Service Categories (block 92), Providers' Service Area (block 94), Provider Measurement data reported by customers (block 96), and State and National Averages or “Benchmarks” (block 98) reported by the customers. On the other hand, the AP tables (FIG. 8) 100 may contain data related to agencies/customers (block 102), best practices (BP) at an agency (block 103), agency performance measurement (block 104), agency performance indicators (block 105), BP performance indicators for an agency/customer (block 106), best practice categories (block 108), and best practices (block 110), as shown in more detail in FIG. 8. This home health compare data (block 84, FIGS. 6-7) may be public information generally available through the Center for Medicare & Medicaid Services (CMS). Because of self-explanatory nature of various data elements shown in FIGS. 7-8, additional discussion of FIGS. 7 and 8 is not necessary.

FIG. 9 illustrates an exemplary set of business metrics (or performance indicators) and its association with corresponding areas of operation in the business of a healthcare customer. These business metrics have been shown under block 18 in FIGS. 3-4, and a detailed discussion of the business metrics shown in FIG. 9 have been already provided hereinbefore with reference to discussion of FIG. 3. Hence, such discussion is not repeated herein for the sake of brevity. It is observed that, in one embodiment, a customer's sales, customer support, and consulting departments may provide a significant amount of data related to customer visits, healthcare service utilization, financial matters, AR management, pre-authorization status of insurance claims, etc. These data, as discussed before, may be then analyzed by the AP system of the vendor to provide recommendations to the customer for improvement in one or more areas of its business operations.

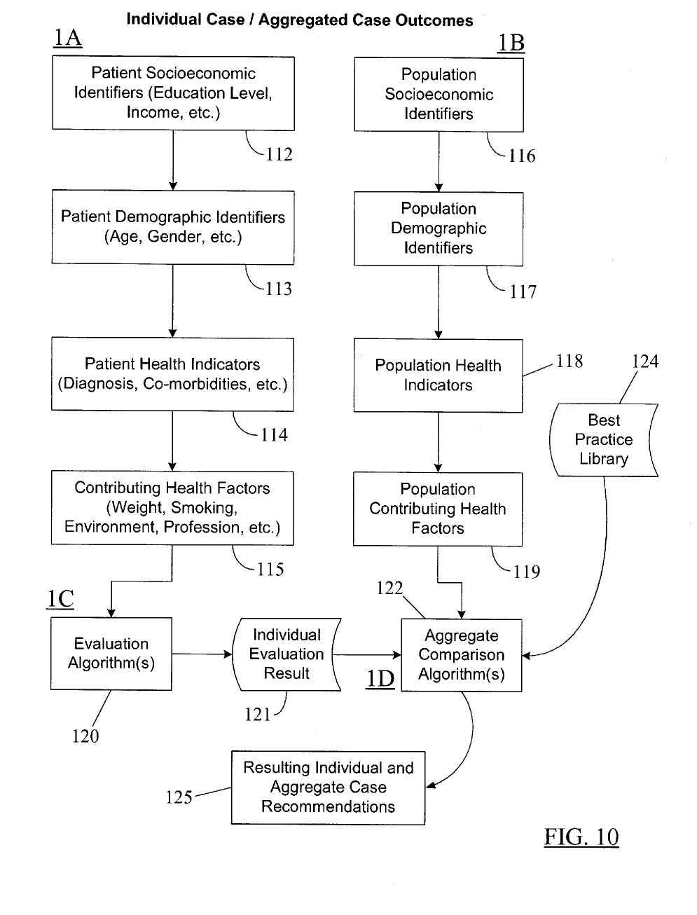

FIG. 10 shows an exemplary flowchart depicting how individual and aggregate case recommendations may be provided by the vendor's AP system upon analysis of specific data collected (e.g., by a customer's representatives) from individual as well from multiple patients (or general population). As indicated under part-1A in the embodiment of FIG. 10, patient-specific data collected by the customer may include data related to patient's socio-economic identifiers (e.g., patient's education level, income, etc.) (block 112), patient's demographic identifiers (e.g., patient's age, patient's gender, etc.) (block 113), patient's health indicators (e.g., patient's diagnosis, patient's co-morbidities, etc.) (block 114), and patient's health factors (e.g., patient's weight, patient's smoking habit, patient's profession, etc.) (block 115). A similar set of data also may be collected from multiple patients or general population in the relevant geographic locale as indicated by blocks 116-119 under part-1B in FIG. 10. The vendor's AP system may receive all such data and apply relevant evaluation algorithms. For example, as shown at part-1C in FIG. 10, patient-specific data from an individual patient may be evaluated to produce an individual patient-specific evaluation result (blocks 120-121) and, as shown at part-1D in FIG. 10, similar evaluation may be performed for the aggregate data from the general population or one or more groups of patients (block 122). In one embodiment, the data repository (shown, e.g., as block 20 in FIG. 4) of the AP system may store a best practice library (block 124) containing relevant patient-specific and population-specific comparative data that can be supplied to evaluation algorithms to generate individual and aggregate case recommendations for the customer (block 125). The best practice library (block 124) may store “suggested” or “recommended” approaches to patient treatments (e.g., by healthcare service providers) in view of a number of relevant business metrics. The case recommendations may be provided to the customer via one or more reporting options discussed hereinbefore with reference to FIGS. 4-5. In one embodiment, the recommendations may include whether a particular patient needs change in his/her treatment plan, whether a group of patients needs additional doctor (or other healthcare service provider) visits, whether a group of patients should change their dietary habits, etc.

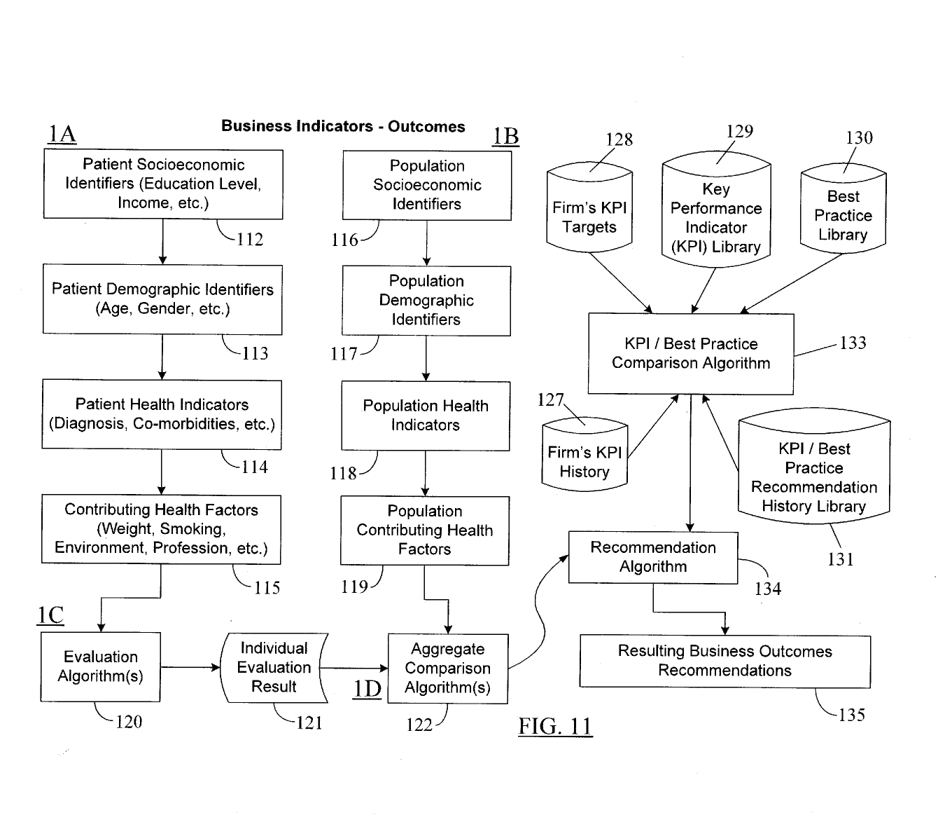

FIG. 11 illustrates an exemplary embodiment depicting how the AP system according to the teachings of the present disclosure may use individual and aggregate data collected as per the embodiment in FIG. 10 with various KPI (key performance indicators) and best practice data to generate business outcome recommendations for a customer. In the embodiment of FIG. 10, patient-specific recommendations for individual and aggregate case management may be generated. Whereas, in the embodiment of FIG. 11, a business-specific recommendation may be generated from evaluation of various patient-specific data. The parts 1A, 1B, 1C, and 1D in FIG. 11 are identical to those shown and discussed with reference to FIG. 10 and, hence, are not discussed herein for the sake of brevity. In the embodiment of FIG. 11, a number KPI and/or best practice data sources in the AP system's data repository (e.g., block 20 shown in FIG. 4) may be consulted by the AP system software to provide firm- or customer-specific KPI/best practice data to a comparison algorithm. In one embodiment, a customer or client firm may specify a set of business metrics (or performance indicators) as “key performance indicators” (KPIs) that may be used by the vendor's AP system in evaluating the aggregate data (e.g., from general population or one or more groups of patients) to generate business outcome recommendations for the firm. In one embodiment, the KPI and best practice data sources may include a client firm-specific historical KPI data (represented as database 127), a client firm-specific KPI targets (represented as database 128), a general (e.g., an industry-specific) KPI and best practice libraries (represented as databases 129, 130, respectively), and a library of client-specific KPI/best practice recommendation history (represented as database 131). Although these data sources 127-131 are represented separately, they need not be so. In one embodiment, they may be stored as part of a single database. These data sources may supply corresponding KPI/best practice data to a KPI/best practice comparison algorithm (block 133), which may generate a customer-specific set of KPI or best practice indicators along with associated data points or “benchmarks.” A recommendation algorithm (block 134) in the AP system may evaluate the individual and aggregate patient data in view of the customer-specific KPI/best practice indicators (generated by the KPI/best practice comparison algorithm at block 133) to generate a customer-specific set of recommended business outcomes (block 135) for the corresponding group of patients (e.g., patients in a specific geographical area or having a specific healthcare need). In this manner, a customer's business practice may be “fine-tuned” with the needs of its patients to optimize delivery of customer's healthcare services to achieve an overall improvement in the “health” and performance of the customer's business.

The foregoing describes a healthcare provider performance analysis and business management system (referred to herein as the “AP system”). The AP system according to the teachings of the present disclosure may thus provide a business-centric analysis of healthcare agency performance indicators so as to provide additional perspective on data points not currently available in other, patient-centric systems or solutions. Unlike the AP system according to the teachings of the present disclosure, the currently-available patient management systems may not be well-equipped to address needs of and offer solutions for a healthcare practice management. The AP system according to one embodiment of the present disclosure allows for performance monitoring of a healthcare business of a customer without requiring the customer to risk a large amount of money for such evaluation. The evaluation of business metrics according to one embodiment of the AP system may proactively identify strengths and weaknesses within a customer's business organization, thereby helping executive management to identify business areas or practices that need the most attention or improvement. In one embodiment, the AP system may create customer-tailored technology solutions that assure measurable and sustainable results. As mentioned before, the benchmark data may “evolve” over time (based on continued data collections from customers), thereby providing proprietary analysis tools to address customers' unique and evolving requirements (pre-, post-benchmarks) and to offer technology solutions to those requirements to enable customers to obtain measurable improvements in business performance. A comparison of a customer's business performance (as indicated by data collected from the customer for a number of business metrics) against best practices at similarly-situated customers of the AP system provider (as represented by the “benchmarks” used for evaluation of business metrics) may allow the AP system provider to provide feedback and best practice recommendation to the customer whose business performance is under evaluation.

A periodic or ongoing monitoring of data for a customer's performance indicators may be set up for a detailed review of the customer's business practices. In one embodiment, new targets or performance levels may be recommended to the customer. Furthermore, the AP system may provide business “intelligence” to identify a weaker competitor(s) to a customer and may even recommend the competitor's acquisition as part of an improved business strategy based on a thorough evaluation of the competitor's performance indicators by the AP system.

The AP system's combinatorial analysis of key operational, clinical, and financial indicators of a customer's business model may result in increased efficiency and improved profitability at the customer's business. The improvements in the customer's business model may ultimately reflect in improvements in the services and products offered to the customer's patients. It is observed here that although the discussion herein is provided with reference to business performance analysis of a healthcare provider, the teachings of the present disclosure may be suitably applied to evaluation and analysis of business performance of any non-healthcare business.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method comprising:
receiving, using a first computing system, business metric-specific data for a plurality of business metrics for a healthcare provider;
analyzing said received data using said first computing system; and
providing a performance report using said first computing system based on said analysis of said received data, wherein said performance report is tailored to said healthcare provider and reports a measurement of business performance of said healthcare provider against said plurality of business metrics.

2. The method of claim 1, wherein said receiving includes:
receiving said business metric-specific data from a second computing system associated with said healthcare provider and configured to maintain a database containing said business metric-specific data.

3. The method of claim 2, wherein said receiving further includes:
periodically automatically retrieving said business metric-specific data from said second computing system using said first computing system.

4. The method of claim 1, wherein said analyzing includes:
evaluating said received data against a pre-determined set of benchmarks related to said plurality of business metrics.

5. The method of claim 4, wherein said pre-determined set of benchmarks includes a portion of one or more of the following:
a first set of publicly-available industry-standard data for healthcare industry;
a second set of proprietary data collected using said first computing system from a plurality of healthcare providers; and
a third set of data calculated using said first computing system from statewide or nationwide averages for said plurality of business metrics.

6. The method of claim 4, wherein said evaluating includes:
selectively assigning different weights to different benchmarks in said pre-determined set of benchmarks so as to generate a set of weighted benchmarks; and
evaluating said received data against said set of weighted benchmarks.

7. The method of claim 1, further comprising:
charging a fee for providing said performance report.

8. The method of claim 1, wherein said business metric-specific data include at least one of financial data, clinical data, and operational data of said healthcare provider.

9. The method of claim 1, wherein said receiving further includes:
receiving a single patient-specific data and multiple patient-specific data for patients in a group of patients served by said healthcare provider;
wherein said analyzing further includes:
evaluating said single patient-specific data against relevant single patient-specific comparative data and evaluating said multiple patient-specific data against relevant population-specific comparative data; and
wherein providing said performance report further includes:
providing an individual patient-specific healthcare treatment recommendation based on evaluation of said single patient-specific data and providing a patient group-specific healthcare treatment recommendation based on evaluation of said multiple patient-specific data.

10. The method of claim 9, wherein said analyzing further includes:
evaluating said single patient-specific data and said multiple patient-specific data against a set of benchmarks related to a set of business metrics from said plurality of business metrics; and
wherein providing said performance report further includes:
providing a set of recommended business outcomes for said group of patients based on evaluation of said single patient-specific data and said multiple patient-specific data against said set of benchmarks related to said set of business metrics.

11. A method comprising:
configuring a first computing system associated with a business entity to maintain a database containing business metric-specific data for a plurality of business metrics for said business entity; and
configuring a second computing system to perform the following:
receive said business metric-specific data from said first computing system,
analyze said received data, and
provide a performance report based on said analysis of said received data, wherein said performance report is tailored to said business entity and reports a measurement of business performance of said business entity against said plurality of business metrics.

12. The method of claim 11, wherein configuring said first computing system includes:
configuring said first computing system to de-identify patient data stored as part of said business metric-specific data.

13. The method of claim 11, wherein configuring said second computing system to receive said business metric-specific data includes:
configuring said second computing system to periodically automatically retrieve said business metric-specific data from said first computing system.

14. The method of claim 11, wherein configuring said second computing system to receive said business metric-specific data includes:
configuring said second computing system to receive said business metric-specific data from said first computing system over a data communication network.

15. The method of claim 11, wherein configuring said second computing system to analyze said received data includes:
configuring said second computing system to evaluate said received data against a pre-determined set of benchmarks related to said plurality of business metrics, wherein said pre-determined set of benchmarks includes a portion of one or more of the following:
a first set of publicly-available industry-standard data for an industry associated with said business entity,
a second set of proprietary data collected using said first computing system from a plurality of business entities in said industry; and
a third set of data calculated using said second computing system from statewide or nationwide averages for said plurality of business metrics.

16. The method of claim 15, wherein configuring said second computing system to evaluate said received data against said pre-determined set of benchmarks includes:
configuring said second computing system to selectively assign different weights to different benchmarks in said pre-determined set of benchmarks so as to generate a set of weighted benchmarks; and
further configuring said second computing system to evaluate said received data against said set of weighted benchmarks.

17. A computer program code, comprising:
a first program code, which, when executed by a first computing system associated with a business entity, configures said first computing system to collect business metric-specific data for a plurality of business metrics for said business entity; and
a second program code, which, when executed by a second computing system, configures said second computing system to:
receive said business metric-specific data from said first computing system, analyze said received data, and
provide a performance report based on said analysis of said received data, wherein said performance report is tailored to said business entity and reports a measurement of business performance of said business entity against said plurality of business metrics.

18. The computer program code of claim 17, wherein said first program code, when executed by said first computing system, configures said first computing system to receive said business metric-specific data from a plurality of users and to maintain a database of user-supplied business metric-specific data.

19. The computer program code of claim 17, wherein said first and said second program codes, when executed by said first and said second computing systems, respectively, configure said first and said second computing systems to communicate with each other via a data communication network, and wherein said second program code further configures said second computing system to periodically automatically retrieve said business metric-specific data from said first computing system over said data communication network.

20. The computer program code of claim 17, wherein said second program code, when executed by said second computing system, configures said second computing system to analyze said received data by evaluating said received data against a pre-determined set of benchmarks related to said plurality of business metrics.
